(19) United States
(12) Patent Application Publication
(10) Pub. No.: US 2008/0109553 A1
(43) Pub. Date: May 8, 2008

(54) System and method for reducing click fraud

(76) Inventor: Brian Fowler, Woslin, FL (US)

Correspondence Address: LOTT & FRIEDLAND, P.A., P.O. BOX 141098, CORAL GABLES, FL, 33114-1098, US

(21) Appl. No.: 11/595,787

(22) Filed: Nov. 8, 2006

(51) Int. Cl. G06F 15/16

(52) U.S. Cl. 709/229

(57) ABSTRACT

The present invention provides a way to reduce click fraud by verifying that a human user is making URI requests. In a preferred embodiment, the present invention comprises a client-side plug-in or other suitable component adapted to: (a) assemble a list of enabled domains; (b) when a user first requests a resource from an enabled domain, modify hyperlinks in the response that target resources in any enabled domain; and (c) when a user attempts to follow a modified hyperlink, present a challenge to the user that the user must successfully negotiate before the user is granted access to the resource targeted by the hyperlink.

### BACKGROUND OF THE INVENTION

Unlike traditional advertising, online advertising can be interactive: a human user indicates interest in an online advertisement by taking an affirmative action with respect to the advertisement, such as following a hyperlink or clicking on an image. The affirmative actions that a user takes with respect to most online advertisements cause the content-delivery application to request a URI; URI requests, in turn, are recorded by the server containing the resource being requested.

As known in the art, URI requests are commonly generated and processed as illustrated in FIG. 1. As shown in FIG. 1, a user 100 performs a user action 102 that results in the web browser 104 issuing a URI request 106. The request 106 is typically sent to the network 108 and a response 110 is received from the network 108. Web browser 104 then causes the response to be displayed to the user 100, as shown at 112. The term “displayed” encompasses without limitation a rendering that may or may not include any visual elements and may or may not include non-visual elements.

Many advertising service providers offer advertising plans in which the advertising service provider records the number of URI requests for an advertiser's advertisements; the charge to that advertiser is a function of the number of URI requests that are recorded. Such advertising plans are commonly called “pay-per-click” plans. Some advertising service providers meter the display of particular advertisements based in whole or in part on the number of URI requests received for those advertisements. For instance, an advertising service provider may cap the absolute number of displays of a particular advertisement or group of advertisements in a specified time period after a certain number of associated URI requests are received. Alternatively, the advertising service provider may alter the frequency with which any given advertisement or any advertisement from a given group of advertisements appears in a specified time period as the number of associated URI requests increases.

Pay-per-click plans such as those described can be exploited through “click fraud”: the creation of URI requests for an advertisement that are not associated with any human's interaction with that specific advertisement. Click fraud increases the cost of advertising to the advertiser, because the price paid by the advertiser rises with the number of recorded URI requests. Click fraud also reduces the availability, and therefore the potential effectiveness, of advertisements or groups of advertisements with respect to those advertising service providers who limit the display of advertisements based on associated URI requests. A particular automated URI request (a “fraudulent click”) may be issued by a “bot” or “crawler”: software that automatically traverses hyperlinks on the Internet, often for the purpose of populating search engine indexes. Fraudulent clicks may also result from software created for the express purpose of committing click fraud.

While advertising service providers try to correct for click fraud by not including or discounting some URI requests when calculating overall advertising price, it is not possible to know with certainty the success of such corrections because it is not always feasible to determine whether any given URI request was fraudulent after the fact.

Since the late 1990s, computer scientists have been developing verification challenges that seek to determine whether a user is in fact a human. Verification challenges are designed so that most humans are able to successfully complete the challenge most of the time whereas most computer programs fail the challenge most of the time. The most common types of verification challenges involve presentation of an image containing random, distorted text strings to the requesting entity. To successfully complete the challenge, the requesting entity must enter one or more of the random text strings found in the image.

Server-based verification challenges have been deployed by many websites to control access to particular resources. Server-based verification can be achieved with special webpages where the target URIs of hyperlinks always point to a challenge page rather than to the actual desired resource; server-based verification can also be achieved by configuring the server hosting the webpage to intercept or redirect certain predetermined URI requests rather than permitting direct access to the resources associated with the requests. In either case, successful verification by the user eventually allows display of the desired resource to the user.

Several major Internet companies require verification before allowing a user to sign up for a user account, complete an online purchase or send bulk e-mail. Verification challenges have been suggested for prevention of software-driven voting fraud in online polls, as an additional step in authentication to a trusted computer and to prevent automated systems from clicking through online advertisements.

### SUMMARY OF THE INVENTION

The present invention provides a way to reduce click fraud by verifying that a human user is making URI requests. In a preferred embodiment, the present invention comprises a client-side plug-in or other suitable component adapted to: (a) assemble a list of enabled domains; (b) when a user first requests a resource from an enabled domain, modify hyperlinks in the response that target resources in any enabled domain; and (c) when a user attempts to follow a modified hyperlink, present a challenge to the user that the user must successfully negotiate before the user is granted access to the resource targeted by the hyperlink.

### BRIEF DESCRIPTION OF THE FIGURES

FIG. 1 is a flow diagram illustrating processing of a URI request in the prior art;

FIG. 2 is a block diagram depicting aspects of a preferred embodiment of the present invention;

FIG. 3 is an illustration of a webpage and its content in a preferred embodiment of the present invention;

FIG. 4 is a flow diagram depicting a preferred embodiment of a lifecyle in the present invention;

FIG. 5 is a flow diagram depicting a preferred embodiment for handling of intercepted URI requests in the present invention;

FIGS. 6A-6F are flow diagrams depicting preferred embodiments for processing a URI request in the present invention; and

FIG. 7 is a flow diagram depicting a preferred embodiment for rewriting a hyperlink in the present invention.

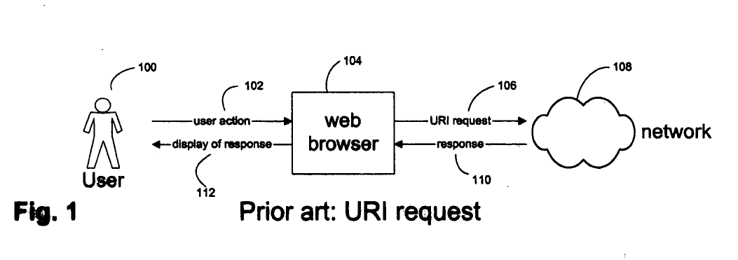

### DETAILED DESCRIPTION OF THE INVENTION

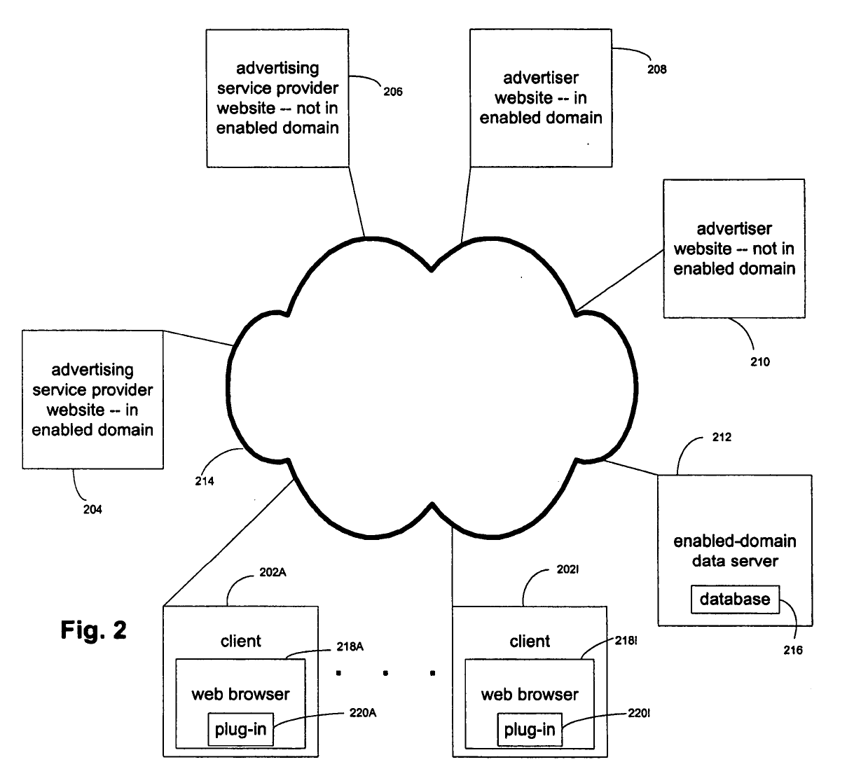

With reference to FIG. 2, there is shown a networked environment 200 comprising a plurality of clients 202A-202I, a first advertising service provider website 204, a second advertising service provider website 206, a first advertiser website 208, a second advertiser website 210, and an enabled-domain data server 212, all connected to a network 214 such as the Internet. Each client 202A-202I may preferably be a computer workstation comprising a CPU, memory, a display, and input devices such as a mouse and a keyboard.

Enabled-domain data server 212 preferably maintains a database 216 that stores information identifying enabled domains. The list of enabled domains in the preferred embodiment is preferably maintained by the owners or operators of the enabled-domain data server; the owners or operators may charge a fee to entities and individuals that wish to register a domain as an enabled domain. As described in more detail below, in a preferred embodiment, when a user is first presented with a resource from an enabled-domain (for instance, a webpage from an enabled domain) and attempts to follow a link embedded in the resource that targets a second resource in any enabled domain, he or she is presented with a challenge that must be successfully negotiated before the second resource is displayed to the user.

As known in the art, a “domain” is a set of network-attached devices such as servers. A domain can be described by a set of fully qualified or partially qualified domain names, IP addresses, subnets or similar nomenclature. For example, *.theglobe.com would specify a domain comprising a.theglobe.com, b.theglobe.com and any other network-attached device associated with a fully qualified domain name having “theglobe.com” as its second-level domain.

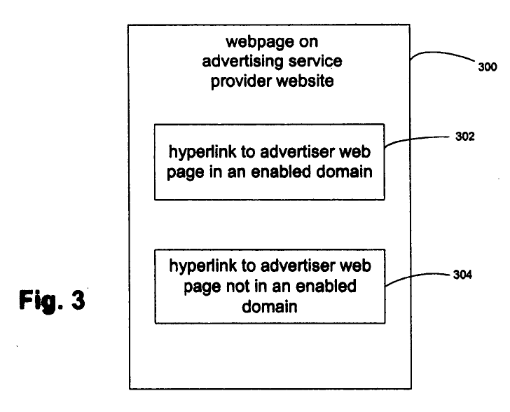

For purposes of illustration, it will be assumed in the following description that advertising service provider website 204 is in an enabled domain and advertising service provider website 206 is not, and that advertiser website 208 is in an enabled domain and advertiser website 210 is not. It will be further assumed that advertising service provider website 204 and advertising service provider website 206 contain exact copies of the same webpage, represented as webpage 300 in FIG. 3. As shown in FIG. 3, webpage 300 may illustratively contain a first hyperlink 302 with a target URI that identifies an enabled-domain resource, such as a resource available from advertiser server 208, and a second hyperlink 304 with a target URI that identifies a resource not associated with any enabled domain, such as a resource available from advertiser server 210.

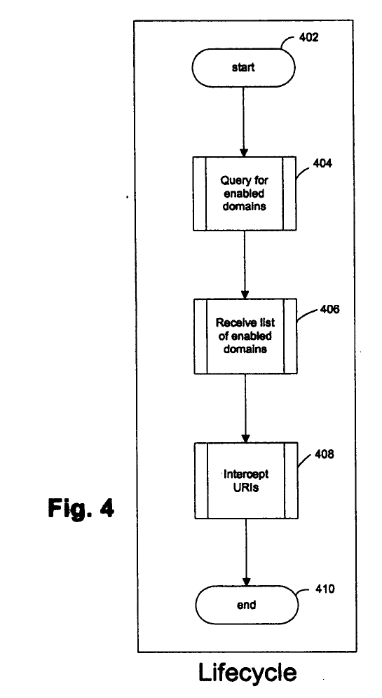

As described in more detail below in connection with FIGS. 4-6, a web browser 218A-218I comprising a plug-in 220A-220I is preferably installed on each client 202A-202I. The plug-in is preferably adapted to (a) assemble a list of enabled domains; (b) when a user requests an enabled-domain resource for the first time, modify hyperlinks in the response that target resources in any enabled domain; and (c) when a user attempts to follow a modified hyperlink, present a challenge to the user that the user must successfully negotiate before the resource targeted by the hyperlink is displayed to the user. Alternatively, the functionality described as provided by plug-in 220 may instead be provided in whole or in part by other suitable means such as a proxy server standing between the client and the network.

In a preferred embodiment, the present system and method operate in defined lifecycles, also called sessions, as will now be described in connection with FIG. 4. As shown in FIG. 4, at step 402, a session is commenced. In a preferred embodiment, a session may be deemed to commence when a new browser window or tab is opened. In such an embodiment, two URI queries from the same web browser on the same client resulting from two distinct actions of the same user with respect to that web browser will be associated with two different sessions if the distinct actions involve distinct browser windows or tabs. Alternatively, a session may be deemed to commence when a new web browser instance is launched, but all windows and all tabs within that instance are deemed a single session. In such an alternative embodiment, two URI queries from the same web browser on the same client resulting from two distinct actions of the same user with respect to that web browser will be associated with the same session so long as the instance of the browser is not terminated between user actions. Two URI queries resulting from two distinct user actions on the same client within different web browsers, however, would result in queries associated with two distinct sessions.

Where some or all functionality of the plug-in is implemented on a proxy server, a session preferably begins after the startup sequence of the proxy server whenever a query from a new IP address, MAC address or similar identifier is received. In such an embodiment, a session is associated with an IP address, MAC address or similar identifier and two URI queries resulting from two distinct actions of the same user on the same client will be associated with the same session so long as the client's IP address, MAC address or similar identifier remains constant with respect to the two distinct actions.

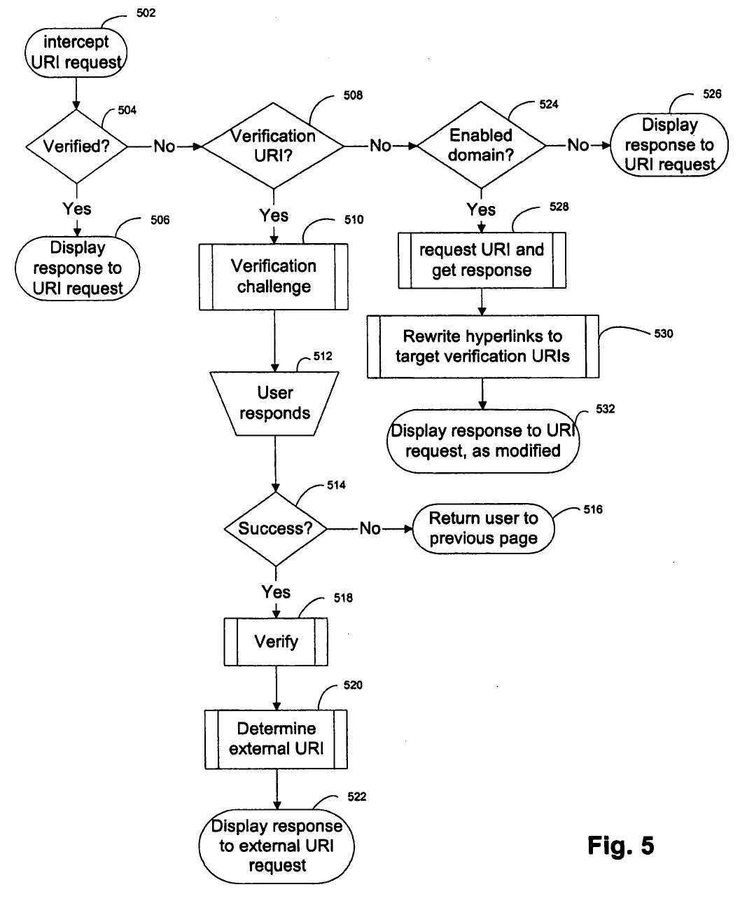

In step 404, plug-in 220 formulates and executes a URI query, RPC query or similar query for a list of enabled domains to enabled-domain data server 212 over network 214. In step 406, this list of enabled domains is retrieved from database 216 and transmitted from enabled-domain data server 214 to client 202 via network 214, where the list is stored by plug-in 220 for the duration of the session. In step 408, plug-in 220 intercepts and processes URI requests generated by web browser 218 as described in more detail below in connection with FIGS. 5-8. In step 410, the session preferably concludes.

For embodiments where a session begins whenever a new web browser window or tab is opened, that session preferably ends when the web browser window or tab that started the session is closed. If the session begins at web browser startup and no additional sessions are started when new windows or tabs are opened, the session preferably ends when the last window or tab is closed. When a session begins after proxy-server startup or on receipt of a query by a new IP address, MAC address or similar identifier, the session preferably ends after a reasonable, predetermined timeout interval of user inactivity has passed (e.g., 30 minutes) or as part of the shutdown sequence of the proxy server.

Each intercepted URI request 408 is preferably handled in a manner that can be logically described, with reference to FIG. 5, according to a decision model 500. When a URI request is intercepted (step 502), plug-in 220 determines whether the session with which the request is associated has been “verified” by, for example, checking a session-level variable allocated to maintain verified status for the session (step 504). As described below, a session is verified where the user has properly responded to a verification challenge within the same session. Thus, incorporation of decision step 504 results in an embodiment in which the user must successfully respond to a verification challenge no more than once per session; after a successful response, the user is permitted to navigate to any web page (whether or not of an enabled domain) without further challenge.

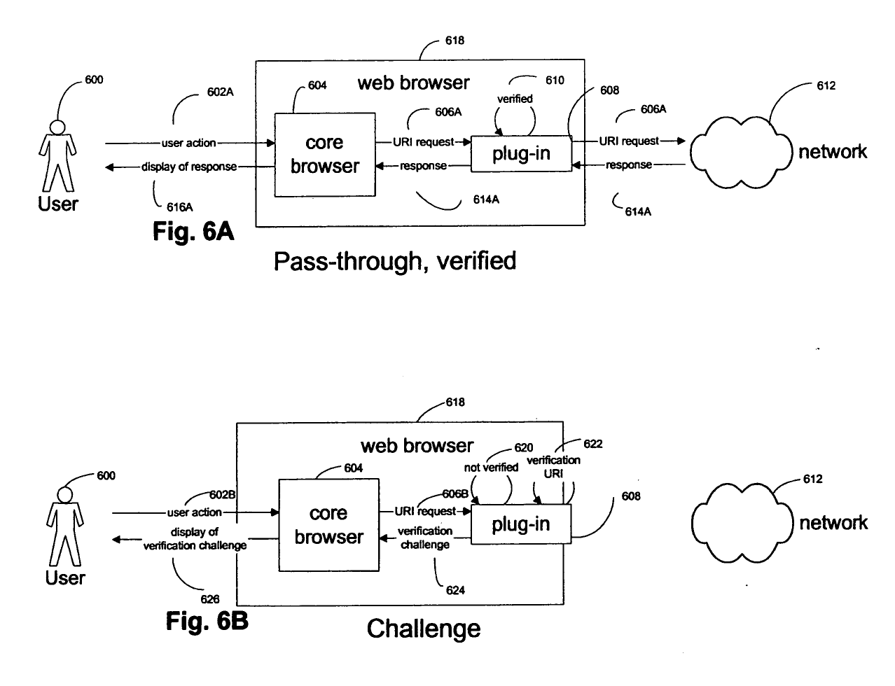

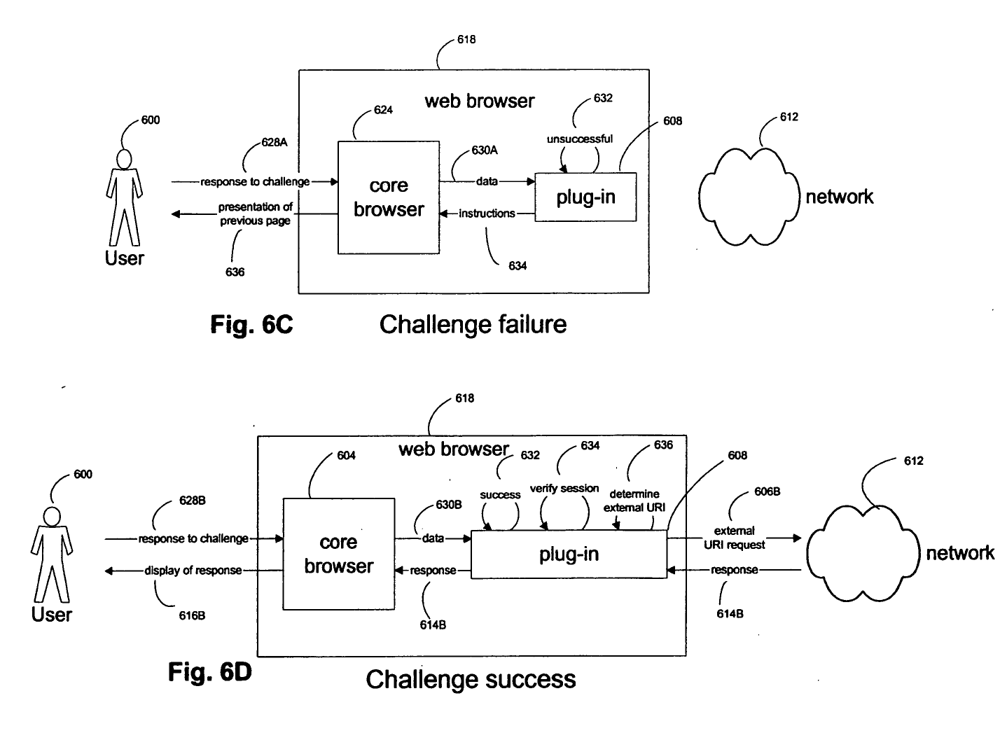

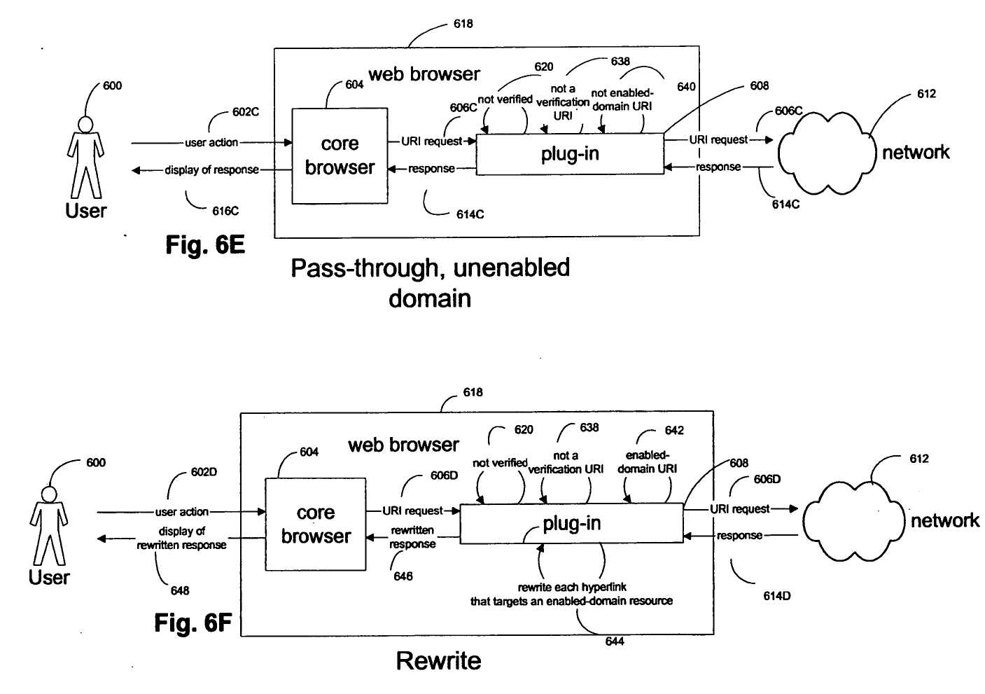

If the session has been verified (step 504, Yes), the response to the URI request will be displayed (step 506). This branch of the decision model comprising steps 502, 504, and 506 is illustrated in FIG. 6A. As shown in FIG. 6A, user 600 performs a user action 602A that results in core browser 604 performing a URI request 606A. After plug-in 608 intercepts URI request 606A from core browser 604, plug-in 608 determines that URI request 606A is associated with a verified session 610 and passes on request 606A to network 612, unless request 606A would not normally be sent to network 612 in the absence of plug-in 608 (e.g., a URI that resolves locally). A response 614A is received from network 612 and passed back to core browser 604. Core browser 616A then causes display of the response 616A to user 600. The behavior illustrated in FIG. 6A can be described as “pass-through verified” behavior. It is “pass-through” behavior because the user action results in a URI request that is passed through plug-in 608 without modification out to network 612 and because the response from network 612 is passed through plug-in 608 without modification back to core browser 604. It is “pass-through verified” because, as distinct from other pass-through behavior described below, the pass-through occurs because the session is verified. For purposes of the present description, it is assumed that web browser 618 comprises both core browser 604 and plug-in 608 at the time it is launched. Otherwise, user 600 may first install plug-in 608, for example, by downloading plug-in software from an appropriate web site, such as a web site associated with enabled-domain data server 212.

In an alternative embodiment, URI request 606A is modified by plug-in 608 before it is passed to network 612. The modification alters the referred-by field in URI request 606A to indicate that the request was associated with a verified session, either by modifying the URI in the referred-by field, for instance, by adding a query parameter, or by replacing the URI altogether. As those skilled in the art will recognize, this modification will not affect the response 614A to the URI request and will not affect any other aspect of user 600's experience; the difference that will result from the modification in this alternative embodiment will be that the referred-by data in log files on the server from which enabled-domain resources are being requested will indicate that certain URI requests came from verified sessions.

Turning back to FIG. 5, if the plug-in determines that the request is associated with a session that has not been verified (step 504, No), the plug-in determines whether the requested URI is a verification URI, as depicted in step 508. In a preferred embodiment, a verification URI is a URI that is generated by the plug-in for insertion into links that target enabled-domain resources and cause the plug-in to present a verification challenge to the user when he or she follows the link. For instance, one preferred embodiment has verification URIs such as x-verify-http://a.theglobe.com, where the scheme or protocol portion of the URI signals that the plug-in should handle the URI. Another preferred embodiment has verification URIs such as http://verify-plug-in-local?id=4A6F686E20506F6C69746F, where the hostname portion of the URI signals that the plug-in should handle the URI.

If the requested URI is a verification URI (step 508, Yes), the plug-in presents the user with a verification challenge 510. These aspects of the decision model comprising steps 508 and 510 are illustrated in FIG. 6B. As shown in FIG. 6B, user 600 performs user action 602B that results in core browser 604 performing URI request 606B. After plug-in 608 intercepts URI request 606B from core browser 604, plug-in 608 determines that the session associated with URI request 606B is not verified 620 and that the requested URI is in fact a verification URI 622. Plug-in 608 submits a verification challenge instruction 624 to core browser 604. Core browser 604 causes display of a verification challenge 626 to user 600. In a preferred embodiment involving a dialog box, plug-in 608 submits a verification challenge instruction 624 causing core browser 604 to display a dialog box in which the verification challenge is presented. In a preferred embodiment involving a challenge page, plug-in 608 submits a verification challenge instruction 624 that is a response to URI request 606B, causing core browser 604 to display a webpage in which the verification challenge is presented. The behavior depicted in FIG. 6B can be described as “challenge” behavior, because the user action results in a URI request that results in the user's being presented with a verification challenge.

Turning back to FIG. 5, after the user responds to the displayed verification challenge (step 512), the plug-in determines whether the response was successful (step 514). If the response was not successful (step 514, No), the user is returned to the page from which the user took the action that resulted in a request for a verification URI (step 516). These aspects of the decision model comprising steps 512, 514 and 516 are illustrated in FIG. 6C. As shown in FIG. 6C, user 600 responds to the verification challenge 628A and core browser 604 relays the response 630A to plug-in 608. Plug-in 608 determines that user 600's response was unsuccessful 632 and sends instructions 634 to core browser 604 that cause the core browser to display the previous page 636 to user 600. In a preferred embodiment where the verification challenge is presented in the form of a dialog box, data 630A comprises the data entered by user 600 into the dialog box and instructions 634 instruct core browser 604 to close the dialog box, resulting in user 600 seeing the page on which user 600 took user action 602B that resulted in the verification challenge (i.e., the previous page). In a preferred embodiment where the verification challenge is presented in the form of a webpage, data 630A is a URI request and instructions 634 are a response to a URI request that causes core browser 604 to display the previous page. In an alternative preferred embodiment where the verification challenge is presented in the form of a webpage and data 630A is a URI request, the instructions 634 instruct core browser 604 to navigate the browser history and return to the previous page. The behavior depicted in FIG. 6C can be described as “challenge failure” behavior, because the plug-in acts in response to the user's failure to successfully complete the verification challenge.

Turning back to FIG. 5, if the plug-in determines that the user response was successful (step 514, Yes), the plug-in verifies the session (step 518) by, for example, setting a session variable allocated to maintain verification status for the session. In step 520, the plug-in determines the external URI associated with the verification URI 520. In a preferred embodiment, a verification URI is associated with a second URI called an external URI. The external URI identifies the resource to be requested upon successful completion of the verification challenge resulting from a request for the verification URI. In one preferred embodiment, the plug-in maintains a session-level variable such as a lookup table that associates verification URIs or portions thereof with external URIs and retrieval of the external URI is accomplished by looking up the entry corresponding to the verification URI in the lookup table. In another preferred embodiment, the external URI is maintained as part of the verification URI, for instance as a query parameter, and retrieval of the external URI is accomplished by parsing the verification URI according to a predefined algorithm such as reading the external URI from the appropriate query parameter.

In step 522, the plug-in sends a request for the external URI to the network and displays the result. These aspects of the decision model comprising steps 512, 514, 518, 520 and 522 are illustrated in FIG. 6D. As shown in FIG. 6D, user 600 responds to the verification challenge 628B, and core browser 604 relays data 630B to plug-in 608. Plug-in 608 determines that the user response was successful 632. Plug-in 608 verifies the session 634 and determines the external URI associated with the verification URI 636. Plug-in 608 then passes a request for the external URI that was associated with the verification URI 606B to network 612, unless request 606B would not normally be sent to network 612 in the absence of plug-in 608. Plug-in 608 receives response 614B and passes it to core browser 604, which causes display of the response 616B to user 600. The behavior depicted in FIG. 6D can be described as “challenge success” behavior, because the plug-in determines that the verification challenge was completed successfully and executes a URI request for a resource to be displayed to the user.

Turning back to FIG. 5, if the plug-in determines that the requested URI is not a verification URI (step 508, No), the invention then determines whether the requested URI is associated with an enabled domain (step 524). If the requested URI is not associated with an enabled domain (step 524, No), the response to the URI request will be displayed (step 526). The branch of the decision model comprising steps 502, 504, 508, 524 and 526 is illustrated in FIG. 6E. As shown in FIG. 6E, user 600 performs user action 602C that results in core browser 604 performing URI request 606C. After plug-in 608 intercepts URI request 606C from core browser 604, plug-in 608 determines that the session is not verified 620, that the URI requested is not a verification URI 638, and that the URI is not associated with an enabled domain 640 by, for example, comparing the URI to the list of assembled enabled domains. Plug-in 608 passes on request 606C to network 612, unless request 606C would not normally be sent to network 612 in the absence of plug-in 608. Response 614C is received from network 612 and passed back to core browser 604, which causes display of the response 616C to user 600. The behavior depicted in FIG. 6E can be described as “pass-through unenabled domain” behavior. It is “pass-through” behavior for reasons analogous to those described above in the discussion of FIG. 6A. It is “pass-through unenabled domain” because, whereas the pass-through associated with FIG. 6A occurs because the session was verified, the pass-through associated with FIG. 6E occurs because the URI being requested is not associated with an enabled domain.

The distinction can be made clear by examining the behavior of client 202 making two different URI requests for webpage 300. A request for webpage 300 from advertising service provider website 206 will always result in “pass-through unenabled domain” behavior, because advertising service provider website 206 is not in an enabled domain. A request for webpage 300 from advertising service provider 204, however, will result in pass-through behavior only if the associated session has been verified, because advertising service provider website 204 is in an enabled domain; if the associated session is not verified, pass-through behavior will not occur.

Thus, in a preferred embodiment, the present system and method results in different behaviors with respect to the exact same webpage deployed on different websites because of the enabled domain data stored in database 216 on enabled-domain data server 212 rather than because of any configuration differences between advertising service provider website 204 and advertising service provider website 206.

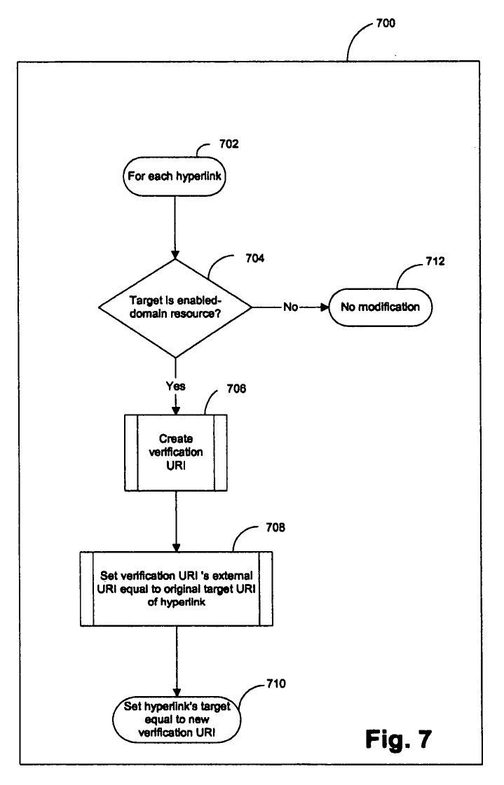

Turning back to FIG. 5, if the requested URI is associated with an enabled domain (step 524, Yes), the invention requests the resource associated with the URI and receives the response (step 528), rewrites the response (step 530) and then displays the rewritten response (step 532). This branch of the decision model comprising steps 502, 504, 508, 524, 528, 530 and 532 is illustrated in FIG. 6F. As shown in FIG. 6F, user 600 performs user action 602D that causes core browser 604 to send URI request 606D, which is intercepted by plug-in 608. Plug-in 608 determines that the session is not verified 620, that the URI requested is not a verification URI 638 and that the requested URI is associated with an enabled domain 642 by, for example, comparing the URI to the list of assembled enabled domains. URI request 606D is sent to network 612, unless request 606D would not normally be sent to network 612 in the absence of plug-in 608. Plug-in 608 receives response 614D and rewrites each hyperlink in the response that targets an enabled-domain resource 644, as will be described below in connection with FIG. 7. The rewritten response 646 is passed back to the core browser 604. The core browser 604 causes display of the rewritten response 648 to user 600. The behavior described in FIG. 6F can be described as “rewrite” behavior, because the response to the URI request is rewritten by the plug-in. For instance, if client 202 requested webpage 300 from advertising service provider website 204, the response to the request would be rewritten because the request for webpage 300 on website 204 is a request for a resource associated with an enabled domain.

The rewriting of the response by the plug-in is preferably accomplished in a manner that can be logically described, with reference to FIG. 7, according to a decision model 700. As shown in FIG. 7, rewriting of the response is accomplished by processing each hyperlink in the response (step 702). If a hyperlink's target is an enabled-domain resource (step 704, Yes), the plug-in creates a verification URI (step 706), associates the original target URI of the hyperlink as the external URI for the verification URI (step 708) and alters the hyperlink in the response so that the target is the newly constructed verification URI (step 710). If the hyperlink does not target an enabled-domain resource (step 704, No) the hyperlink is not modified (step 712).

Because the present system and method preferably rewrites hyperlinks that target URIs associated with enabled domains, not every hyperlink on a webpage containing hyperlinks will typically be rewritten. For instance, if webpage 300 were requested from website 204 by client 202 and the associated session had not yet been verified, hyperlink 302 would be rewritten because it targets a resource associated with an enabled domain, but hyperlink 304 would not be rewritten because it targets a resource not associated with an enabled domain.

A person having ordinary skill in the art will recognize that many of the steps in decision model 500 could be reordered without changing the outcome given any particular set of circumstances. For instance, the determinations of whether a session is verified (step 504), whether a URI is a verification URI (step 508) and whether a URI is associated with an enabled domain (step 524) could be performed in any order or concurrently, and the steps of verifying a session (step 518) and of retrieving the external URI associated with a verification URI (step 520) could happen in any order or concurrently.

While the present invention has been described in conjunction with specific embodiments, it is evident that numerous alternatives, modifications, and variations will be apparent to those skilled in the art in view of the foregoing description.

1. A method for verifying a user before permitting access to electronic resources, comprising the steps of:
intercepting a URI request associated with a session;
if the associated session has not been verified and the URI request identifies a resource requiring verification:
challenging for verification;
if the verification challenge is completed successfully:
verifying the session;
displaying to the user a response to the URI request.

2. The method of claim 1, wherein the resource comprises an advertisement.

3. A method of rewriting hyperlinks so as to require verification before the hyperlinks are accessed, comprising the steps of:
intercepting a URI request;
requesting the resource associated with the URI request;
if the associated session has not been verified and the requested URI is associated with an enabled domain, rewriting the response to the URI as follows:
determining the original target URI for a hyperlink within the response;
if the original target URI for the hyperlink is associated with an enabled domain:
creating a verification URI that identifies a verification resource and is associated with the original target URI for the hyperlink;
rewriting the hyperlink so as to target the verification URI;
returning the response.

4. The method of claim 3, wherein the verification resource is a browser plug-in.

5. The method of claim 3, wherein the verification resource is a web application.

6. The method of claim 3, wherein the verification resource is a stand-alone application.

7. The method of claim 3, wherein the verification resource is a web service.

8. The method of claim 3, wherein the hyperlink targets an advertisement.

9. A system for reducing click-fraud, comprising:
a module for rewriting hyperlinks so as to require verification before the hyperlinks are accessed;
a module for requiring verification before hyperlinks can be accessed; and
a method for determining whether a URI is associated with an enabled-domain resource, comprising:
creating a list of domains that are enabled;
maintaining this list on a queryable, network-attached device; and
querying to obtain the list of enabled domains.

10. The system of claim 9, wherein the module for rewriting hyperlinks and the module for requiring verification are both part of a browser plug-in.

11. The system of claim 9, wherein the module for rewriting hyperlinks and the module for requiring verification are both on a proxy server.
